(19) United States
(12) Patent Application Publication
(10) Pub. No.: US 2014/0275408 A1
(43) Pub. Date: Sep. 18, 2014

(54) PATIENT POSITIONING APPARATUS AND METHOD OF MANUFACTURE

(71) Applicant: Randall Surgical Corporation d/b/a EcoSurg, Memphis, TN (US)

(72) Inventor: Michael Ray Randall, Greenville, SC (US)

(21) Appl. No.: 13/832,356

(22) Filed: Mar. 15, 2013

(51) Int. Cl. C08G 71/04

(52) U.S. Cl. CPC C08G 71/04
USPC 524/590

(57) ABSTRACT

Disclosed herein is a family of patient positioners that are formed as a reaction product of substantially plant based constituents. In particular, surgical grade foam positioners are configurable in a variety of anatomically acceptable forms are disclosed that are substantially odor free.

### BACKGROUND

This technology relates generally to plant based foam production and, more particularly, to medical grade patient positioners composed at least in part of plant based polyols.

In surgical procedures it is often necessary to position various regions of a patient's body for optimal access. In particular, surgeons often use positioning means to position the cephical/cranial regions, cervical region, dorsal/thorax regions, abdominal region and the upper and lower extremities of a patient, with varying levels of success. It may turn out that positioners for each of the body regions of a patient require differing performance characteristics and these positioners often create potential problems because they are difficult to manufacture to adequately accommodate the wide anatomical diversity of patients. Moreover, these positioners are particularly problematic in procedures that involve cephical, cranial or cervical positioning because often this requires the patient's face to be in close proximity to the positioner. With these positioners being produced through the use of petroleum based polyols and carcinogenic starting materials, the off-gassing of these positioners could cause adverse reactions in patients.

### BRIEF SUMMARY

Disclosed herein is a family of patient positioners that are formed as a reaction product of substantially plant based constituents. In particular, surgical grade foam positioners are configurable in a variety of anatomically acceptable forms are disclosed that are substantially odor free.

These and other advantageous features of the present invention will be in part apparent and in part pointed out herein below.

### BRIEF DESCRIPTION OF THE DRAWINGS

For a better understanding of the present invention, reference may be made to the accompanying drawings in which:

FIG. 1 is a schematic illustration of a polymer manufacturing process of a type disclosed herein;

FIG. 2a is a perspective view of surgical positioners typical of the type manufactured by a process disclosed herein suitable for cephical/cranial/cervical positioning;

FIG. 2b is a perspective view of a surgical positioner typical of the type manufactured by a process disclosed herein suitable for lower extremity positioning;

FIG. 2c is a perspective view of a surgical positioner typical of the type manufactured by a process disclosed herein for upper extremity positioning;

FIG. 2d is a perspective view of a surgical positioner typical of the type manufactured by a process disclosed herein for upper and/or lower extremity positioning;

FIG. 3 is a perspective view of a surgical positioner typical of the type manufactured by a process disclosed herein suitable for cephical/cranial/cervical positioning with additional perspective view of alternative die for aperture formation;

While the invention is susceptible to various modifications and alternative forms, specific embodiments thereof are shown by way of example in the drawings and will herein be described in detail. It should be understood, however, that the drawings and detailed description presented herein are not intended to limit the invention to the particular embodiment disclosed, but on the contrary, the intention is to cover all modifications, equivalents, and alternatives falling within the spirit and scope of the present invention as defined by the appended claims.

### DETAILED DESCRIPTION OF INVENTION

According to the embodiment(s) of the present invention, various views are illustrated in FIG. 1-X and like reference numerals are being used consistently throughout to refer to like and corresponding parts of the invention for all of the various views and figures of the drawing. Also, please note that the first digit(s) of the reference number for a given item or part of the invention should correspond to the Fig. number in which the item or part is first identified.

According to the embodiment(s) of the present invention, various views are illustrated in FIG. 1-4 and like reference numerals are being used consistently throughout to refer to like and corresponding parts of the invention for all of the various views and figures of the drawing.

One embodiment of the present technology comprising plant based oils teaches a novel foam cushion apparatus and method for making foam with starting materials containing plant based components.

The details of the invention and various embodiments can be better understood by referring to the figures of the drawing. Referring to FIG. 1, a schematic illustration is provided of a polymer manufacturing process 10 of a type disclosed herein for making foam work pieces 600.

In a typical polymer production process bulk storage of the constituent components are fed to smaller holding chambers from which the constituents are drawn in relevant proportion to be reacted with one another to form the polymer. The resulting polymer is then molded and further processed as necessary. In such a process, polymer is the reaction product of petroleum isocyanates and polyols. Additives are frequently provided as well.

While polyurethane polymers are used for a vast array of applications, their production method can be broken into three distinct phases. First, the bulk polymer product is made. Next, the polymer is exposed to various processing steps. Finally, the polymer is transformed into its final product and shipped. This production process can be illustrated by looking at the continuous production of polyurethane foams.

At the start of polyurethane foam production, the reacting raw material constituents are generally held as liquids in large, stainless steel tanks. These tanks are equipped with agitators to keep the materials fluid. A metering device is attached to the tanks so that the appropriate amount of reactive material can be pumped out. A typical ratio of polyol to diisocyanate is 1:2. Since the ratio of the component materials produces polymers with varying characteristics, it is strictly controlled.

The reacting materials are passed through a heat exchanger as they are pumped into pipes. The exchanger adjusts the temperature to the reactive level. Inside the pipes, the polymerization reaction occurs. By the time the polymerizing liquid gets to the end of the pipe, the polyurethane is already formed. On one end of the pipe is a dispensing head for the polymer.

The dispensing head is hooked up to the processing line. For the production of rigid polyurethane foam insulation, a roll of baking paper is spooled at the start of the processing line. This paper is moved along a conveyor and brought under the dispensing head.

As the paper passes under, polyurethane is blown onto it. As the polymer is dispensed, it is mixed with carbon dioxide which causes it to expand. It continues to rise as it moves along the conveyor. After the expansion reaction begins, a second top layer of paper is rolled on. Additionally, side papers may also be rolled into the process. Each layer of paper contains the polyurethane foam giving it shape. The rigid foam is passed through a series of panels that control the width and height of the foam bun. As they travel through this section of the production line, they are typically dried. At the end of the production line, the foam insulation is cut with an automatic saw to the desired length. The foam bun is then conveyed to the final processing steps that include packaging, stacking, and shipping.

For flexible foam, instead of passing along a conveyor, the polymer is placed in a mold and shaped in large shapes for later processing.

Environmentally friendly vegetable oils can be a valuable source of polyols as well as a suitable substitute for isocyanates in the production of polymers. However the chemistry of some vegetable oils is better suited than others. In order to balance the desired functionality of some vegetable oils with the lower production cost of other vegetable oils; chemical synthesis has been performed on lower cost vegetable oils, with wider commercial availability, to obtain desirable functional groups. This has been performed by methods such as those disclosed in U.S. Pat. No. 7,893,287, which is incorporated in its entirety by this reference

Disclosed herein is an illustrative manufacturing process 10 wherein there are three bulk storage containers. The first bulk storage container 100 contains a non-isocyanate resin, preferably from a plant source such as an epoxylated glyceride. Industrially suitable non-isocyanates are carbonates, which can be synthesized from plant-based oils through expoxylation. For example, cyclocarbonate oligomers can be synthesized as follows:

[chemical structure]

Carbonates may then be used to form hydroxyurethanes by the following method:

[chemical structure]

It may be appreciated by one of ordinary skill in the art, after being apprised of the present disclosure, that many other ways to prepare plant based carbonates with varying carbonate content. For example, carbonated vegetable oils may be produced in accordance with the teachings of U.S. Pat. No. 7,045,577, which is incorporated herein, in its entirety, by this reference.

The second bulk storage container 200 contains a polyol derived from a plant based oil such as a soybean oil, linseed oil, caster oil, etc. Illustrative polyols derived from plant based oils are disclosed in U.S. Pat. Nos. 7,674,925, 7,786,239 and 8,153,746, which are incorporated herein in their entireties by this reference. Optionally, a third bulk storage container 300 contains an additive which could include a colorant, flame retardant, hardener, antimicrobial or other desired additive conventional in the art. Alternatively, in lieu of or in addition to the additive, additional bulk storage containers (not shown) could be provided that contain an isocyanate or petroleum based polyols.

These bulk storage containers 100, 200 and 300 may then be connected to smaller feed containers 120, 220 and 320 via conduits 110, 210 and 310, respectively. The feed containers 120, 220 and 320 are preferably adapted with low pressure circulation pumps 130, 230 and 330, respectively. Moreover, the feed containers 120, 220 and 320 are also preferably adapted with heat exchangers 140, 240 and 340, respectively. By means of the low pressure circulation pumps 130, 230 and 330 and the heat exchangers 140, 240 and 340, the constituents in the feed containers 120, 220 and 320 can be circulated in order to preserve their utility.

When the constituents of each of the feed containers 120, 220, and 320 are needed, they may be fed via conduits 150, 250 and 350 to a mixing chamber 400 where the constituents are reacted to form a reaction product. The reaction product is then translated to a mold/conveyer 500 for subsequent processing.

As discussed above, the manufacturing process 10 can be performed with or without the use of isocyanate as the electrophile and in the presence of petroleum based or petroleum free polyols. However, in an illustrative embodiment, the process 10 is performed with a constituent mixture having an electrophile constituent ratio range of at least about 10:1 to 0:1 isocyanate to non-isocyanate electrophile. In other words, the percentage of electrophile that is non-isocyanate can range preferably 1% to 100% and more preferably in the range of 20% to 100%.

The polyol constituents in manufacturing process 10 may or may not be petroleum based. However, in an illustrative embodiment, the process 10 is performed with a constituent mixture having a polyol constituent ratio range of at least about 10:1 to 0:1 petroleum to plant based polyol. In other words, the percentage of polyol that is non-petroleum based can range preferably 1% to 100% and more preferably in the range of 20% to 100%.

In an illustrative embodiment in accordance with manufacturing process 10, at least twenty percent (20%) of both the electrophile and polyol constituents are derived from plant based sources.

Further details concerning the manufacture, molding and forming of illustrative positioners may be adapted in accordance with the teachings of the U.S. patent application entitled COMFORT APPARATUS AND METHOD OF MANUFACTURE filed by Michael Ray Randall on the same day as the current patent application, the above-reference patent application incorporated in its entirety by this reference.

Referring to FIG. 2a, patient positioners 600 illustrative of the type manufactured by a process disclosed herein are shown generally at 600. These positioners 600 have varying apertures 630, 640 contours 615, and notches 650 are suitable for cephical/cranial/cervical positioning. These positioners 600, having a support portion 610 and a stabilizing portion 620. In exemplary embodiments of positioners 600, the relative firmness of the support portion 610 and the stabilizing portion 620 differ such that the stabilizing portion 620 is firmer than the support portion 610. In yet additional embodiments, the support portion 610 may be more resilient or have greater ball rebound ball rebound characteristics (as identified by procedures in accordance with the ASTM D3574 test standard) than stabilizing portion 620.

Referring to FIG. 2b, differing shaped surgical positioners 600 typical of the type manufactured by a process disclosed herein are shown. These positioners 600 are formed to be suitable for lower extremity positioning.

Referring to FIG. 2c, a surgical positioner 600 typical of the type manufactured by a process disclosed herein is shown. This positioner 600 is formed to be suitable for upper extremity positioning;

Referring to FIG. 2d, a surgical positioner 600 typical of the type manufactured by a process disclosed herein is shown. This positioner 600 is formed to be suitable for upper and/or lower extremity positioning.

FIG. 3 illustrates a foam structure 600, wherein die 660 has been used to create an aperture In fact, two different reaction products, having differing characteristics such as flexibility and resilience, can be molded together to provide a foam structure 600, having a support portion 610 and a stabilizing portion 620, wherein the support portion 610 has a relatively different firmness than the stabilizing portion 620.

As is evident from the foregoing description, certain aspects of the present invention are not limited by the particular details of the examples illustrated herein, and it is therefore contemplated that other modifications and applications, or equivalents thereof, will occur to those skilled in the art. It is accordingly intended that the claims shall cover all such modifications and applications that do not depart from the spirit and scope of the present invention.

Other aspects, objects and advantages of the present invention can be obtained from a study of the drawings, the disclosure and the appended claims.

What is claimed is:

1. An article of manufacture formed from the reaction product of at least one plant based neutrophile; at least one isocyanate free electrophile and at least one additive, comprising a positioner having a stabilizing portion and a support portion, the support portion having a surface contoured to receive and comfortably support a region of a user's anatomy.

2. The article of manufacture of claim 1, wherein the stabilizing portion is firmer than the support portion.

3. The article of manufacture of claim 2, wherein the support portion dimensions are configured to support a region of the user's body selected from the group consisting of the cephical, cranial, cervical, dorsal, thorax, abdominal, upper extremities and lower extremities.

4. The article of manufacture of claim 1, wherein the isocyanate free monomer is a cyclic carbonate.

5. The article of manufacture of claim 1, wherein the neutrophile is soybean based.

6. The article of manufacture of claim 1, wherein the additive is a colorant.

7. The article of manufacture of claim 1, further comprising an isocyanate monomer.

8. The article of manufacture of claim 7, wherein the ratio of isocyanate to electrophilic monomer is at least 10:1 to 1:1.

9. The article of manufacture of claim 7, wherein the ratio of electrophilic monomer to isocyanate is at least 10:1 to 1:1.

10. An article of manufacture, comprised of the reaction product of at least one plant based polyol and at one isocyanate free monomer, wherein said article of manufacture comprises at least about 20%, by weight, plant based polyol.

11. A method of manufacturing a product by reacting at least one plant based neutrophile; at least one isocyanate free electrophilic monomer and at least one additive to form a reaction product; and forming the reaction product into a positioner having a stabilizing portion and a support portion, the support surface contoured to receive and comfortably support a region of a user's anatomy.

12. The method of claim 11, wherein the stabilizing portion is firmer than the support portion.

13. The method of claim 12, wherein the support portion dimensions are configured to support a region of the user's body selected from the group consisting of the cephical, cranial, cervical, dorsal, thorax, abdominal, upper extremities and lower extremities.

14. The method of claim 11, wherein the isocyanate free monomer is a cyclic carbonate.

15. The method of claim 11, wherein the polyol is soybean based.

16. The method of claim 11, wherein the additive is a colorant.

17. The method of claim 11, further comprising an isocyanate monomer.

18. The method of claim 17, wherein the ratio of isocyanate to electrophilic monomer is at least about 100:1 to about 1:1.

19. The method of claim 17, wherein the ratio of electrophilic monomer to isocyanate is at least 100:1 to 1:1.

20. The method of claim 11, wherein the positioner comprises at least about 20%, by weight, plant based polyol.
